(19) United States
(12) Patent Application Publication
(10) Pub. No.: US 2009/0034889 A1
(43) Pub. Date: Feb. 5, 2009

(54) FLUID DYNAMIC BEARING, FLUID DYNAMIC BEARING-TYPE DISC DRIVE, AND METHOD OF MANUFACTURING FLUID DYNAMIC BEARING

(75) Inventors: Masanori UEDA, Kawasaki (JP); Yasuhiro MIURA, Kunitachi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/127,134

(22) Filed: May 27, 2008

(30) Foreign Application Priority Data
May 31, 2007 (JP) 2007-145093

(51) Int. Cl. F16C 32/06; H02K 7/08; B21D 53/10

(52) U.S. Cl. 384/123; 310/90; 29/898.02

(57) ABSTRACT

In a disclosed fluid dynamic bearing motor, and a disc drive employing the same, variations in motor performance due to a change in viscosity of a bearing fluid caused by a temperature change is canceled. The fluid dynamic bearing includes a sleeve with a shaft insertion hole in it. A shaft is rotatably inserted into the shaft insertion hole. A bearing fluid is disposed between an internal surface of the shaft insertion hole and the shaft. The shaft is formed of a material selected from a group consisting of steel, iron alloy material, aluminum alloy material, and copper alloy material. The sleeve is made of titanium material.

### BACKGROUND OF THE INVENTION

1. Field of the Invention

The present invention relates to fluid dynamic bearings.

2. Description of the Related Art

In magnetic disc drives and the like, a fluid dynamic bearing motor is used as a disc rotating motor. Conventional fluid dynamic bearing motors often employ a bearing structure in which the shaft is rotatably supported by a sleeve. In an example of such a bearing structure, a columnar shaft is inserted into an opening in a cylindrical sleeve in such a manner that the shaft can rotate. Because a disc drive motor is required to have a high rotational runout accuracy (=low NRRO), high rigidity, quietness, and long life, a fluid dynamic bearing is often used as a bearing structure. The fluid dynamic bearing includes bearing fluid, such as lubricant oil, disposed between the sleeve and the shaft so that the shaft can rotate without any direct contact with the sleeve.

The shaft of a fluid dynamic bearing motor used in a magnetic disc drive, for example, is often formed of martensitic stainless steel which has high rigidity and relatively good machinability. The sleeve bearing is often formed of copper material which reduces the seizing (adhesion) with the shaft and has good machinability.

The fluid dynamic bearing characteristics vary under the influence of ambient temperature. Specifically, as ambient temperature changes, so does the viscosity of the bearing fluid, resulting in changes in bearing rigidity and torque loss. When the viscosity of bearing fluid (oil) is η, the rotational angular velocity of the shaft is ω, shaft diameter is d, and the clearance between the shaft and the sleeve is c, bearing rigidity and torque loss are expressed as follows:

Bearing rigidity ∝ηωd⁴/c³

Torque loss ∝ηωd⁴/c

Because the bearing fluid viscosity varies depending on ambient temperature, the fluid dynamic bearing motor characteristics also vary.

Specifically, as ambient temperature rises, bearing fluid viscosity decreases and bearing rigidity decreases.

As ambient temperature lowers, bearing fluid viscosity increases and torque loss increases.

Thus, motor performance is greatly influenced by the changes in bearing fluid viscosity which are associated with ambient temperature changes. While it is desirable to keep the bearing fluid viscosity constant in response to temperature changes, development of bearing fluid having such characteristics is technically difficult under the current state of the art.

A fluid dynamic bearing structure has been proposed in which the influence of bearing fluid viscosity changes on motor performance is reduced. In this fluid dynamic bearing structure, the material of the sleeve and the shaft is selected so that the linear coefficient of expansion of the sleeve is smaller than that of the shaft. Specifically, a change in motor performance due to bearing fluid viscosity change is canceled by a change in motor characteristics.

More specifically, as ambient temperature rises, clearance between the shaft and the sleeve is reduced and bearing rigidity is increased.

As ambient temperature lowers, clearance between the shaft and the sleeve is increased and torque loss is reduced.

Thus, the clearance between the shaft and the sleeve is automatically adjusted depending on the difference of the linear coefficients of expansion between the shaft and the sleeve, in order to cancel the influence of bearing fluid viscosity changes. Various combinations of material have been proposed for this purpose.

For example, Japanese Laid-Open Patent Application No. 8-161820 discloses a fluid dynamic bearing in which austenitic stainless steel is used for the shaft and ferrite or martensitic stainless steel is used for the sleeve.

In another example, Japanese Laid-Open Patent Application No. 5-118322 discloses a fluid dynamic bearing in which aluminum alloy is used for the shaft and iron alloy is used for the sleeve.

Further, Japanese Laid-Open Patent Application No. 9-17767 discloses a fluid dynamic bearing in which stainless steel is used for the shaft and Invar material (Fe—Ni alloy) is used for the sleeve.

In yet another example, Japanese Laid-Open Patent Application No. 2003-254325 discloses a fluid dynamic bearing in which martensitic stainless steel is used for the shaft and ceramics is used for the sleeve.

Such combinations of material for the shaft and the sleeve are disadvantageous in the following respects.

When stainless steel is used for both the shaft and the sleeve, seizing (adhesion) may be caused by the sliding or contacting of the same type of metal against each other.

When aluminum alloy is used for the shaft, sufficient rigidity may not be obtained for the shaft.

When Invar material is used for the sleeve, because Invar material is not widely used in the market and is therefore expensive, a cost increase is expected. Furthermore, Invar material has poor machinability, so that it may be difficult to form dynamic pressure grooves (herringbone grooves) in the internal surface of the sleeve.

Because ceramics is expensive, a cost increase is expected when ceramics is used for the sleeve. Ceramics also has poor machinability, so that it may be difficult to form dynamic pressure grooves (herringbone grooves) in the internal surface of the sleeve.

Thus, the various combinations of material for the shaft and the sleeve that have been proposed are problematic in practical use in respect of either motor rigidity, dimensional accuracy, machinability, or cost.

### SUMMARY OF THE INVENTION

It is a general object of the present invention to overcome the aforementioned problems. A more specific object of the present invention is to provide a fluid dynamic bearing motor in which changes in motor performance due to bearing fluid viscosity changes caused by ambient temperature change are canceled. Another object of the present invention is to provide a disc drive in which such a fluid dynamic bearing motor is used.

In one aspect, the invention provides a fluid dynamic bearing comprising a sleeve having a shaft insertion hole; a shaft that is rotatably inserted into the shaft insertion hole of the sleeve; and a bearing fluid disposed between an internal surface of the shaft insertion hole in the sleeve and the shaft. The shaft is formed of a material selected from a group of steel, iron alloy material, aluminum alloy material, and copper alloy material, and the sleeve is made of a titanium material.

In another aspect, the invention provides a fluid dynamic bearing motor including the above fluid dynamic bearing. The shaft is fixed to a rotor and the sleeve is fixed to a stator.

In another aspect, the invention provides a disc drive comprising the above fluid dynamic bearing motor as a disc rotating motor.

In yet another aspect, the invention provides a method of manufacturing a fluid dynamic bearing that rotatably supports a shaft. The method comprises the steps of forming the shaft made of a material selected from a group of steel, iron alloy material, aluminum alloy material, and copper alloy material; making a sleeve that rotatably supports the shaft with titanium material; and forming a dynamic pressure groove on an internal surface of a shaft insertion hole in the sleeve by etching process

In accordance with the present invention, because the sleeve is made of titanium material, the clearance between the shaft and the sleeve changes in such a way as to cancel the influence of a change in viscosity of the bearing fluid between the shaft and the sleeve caused by a temperature change. Thus, the influence of the viscosity change in bearing fluid on motor performance can be reduced, whereby stable motor performance can be obtained within a wide temperature range.

### BRIEF DESCRIPTION OF THE DRAWINGS

Other objects, features and advantages of the present invention will become apparent upon consideration of the specification and the appendant drawings, in which:

FIG. 1 shows a cross section of a fluid dynamic bearing motor according to an embodiment of the present invention;

FIG. 2 shows a partially cross-sectional perspective view of a sleeve of the embodiment shown in FIG. 1;

FIG. 3 shows the structure of a photomask apparatus used for etching an internal surface of a shaft insertion hole;

FIG. 4 shows a flowchart of a process of forming a dynamic pressure groove pattern on the internal surface of the through-hole of the sleeve shown in FIG. 2 using the photomask apparatus shown in FIG. 3;

FIG. 5 shows a flowchart of a process of forming an exposure pattern on the outer surface of a mask member;

FIG. 6 illustrates how the exposure pattern is formed through the process shown in FIG. 5;

FIG. 7 shows a fine groove pattern formed on titanium material;

FIG. 8 shows the result of measuring the profile of the formed groove with a surface roughness meter; and

FIG. 9 shows a table comparing the characteristics of a fluid dynamic bearing using the titanium sleeve and the characteristics of fluid dynamic bearings using sleeves formed of conventional material.

### DETAILED DESCRIPTION OF THE PREFERRED EMBODIMENTS

In the following, an embodiment of the present invention is described with reference to the drawings.

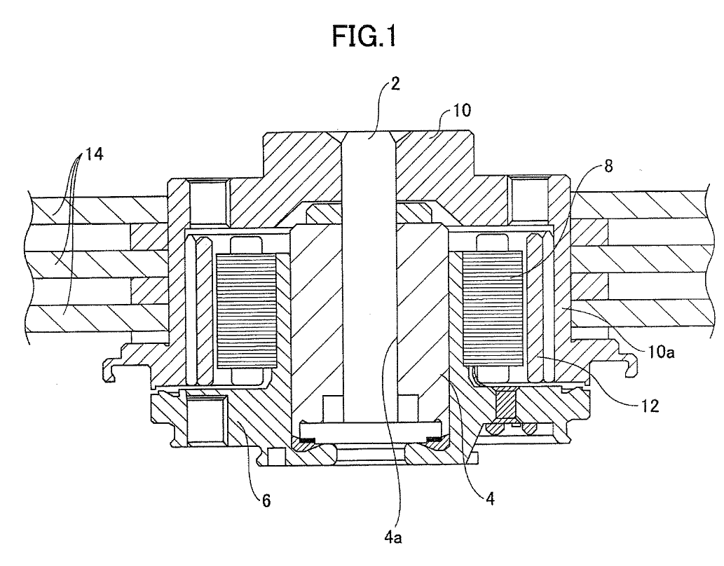

A fluid dynamic bearing motor according to the present embodiment of the invention is described with reference to FIG. 1. FIG. 1 shows a cross section of a fluid dynamic bearing spindle motor according to the present embodiment. The fluid dynamic bearing spindle motor shown in FIG. 1 is used to rotate a disc in a disc drive, such as a magnetic disc drive.

In FIG. 1, a shaft 2 is rotatably inserted into a shaft insertion hole 4a of a sleeve 4. The sleeve 4 is fixed to a stator member 6, on which a stator coil 8 is mounted.

The upper end of the shaft 2 protrudes from the shaft insertion hole 4a of the sleeve 4 and is fixed to a rotor member 10, so that the rotor member 10 can rotate about the shaft 2. The rotor member 10 has a flange portion 10a extending along the axis of the shaft 2. On the inside of the flange portion 10a, a magnet 12 is fixed opposite the stator coil 8, which is attached to the stator member 6, with a slight gap.

As an electric current flows through the stator coil 8, rotating force is generated in the rotor magnet 12, whereby the rotor member 10 is rotated about the shaft 2. Thus, magnetic discs 14 attached to the flange portion 10a of the rotor member 10 can be rotated. By providing a magnetic head and a drive unit for driving the magnetic head near the magnetic discs 14, the embodiment functions as a magnetic disc drive.

In the present embodiment, the shaft 2 is made of martensitic stainless steel such as SUS420J2. The martensitic stainless steel SUS420J2, which is often used as shaft material, has excellent rigidity, good machinability, and corrosion-resistant characteristics. The martensitic stainless steel SUS420J2 has a linear coefficient of expansion of 10.3×10⁻⁶/K. However, the material of the shaft 2 is not limited to the martensitic stainless steel SUS420J2. For example, the material of the shaft may be stainless steel other than martensitic stainless steel; steel other than stainless steel; iron alloy material; aluminum alloy material; or copper alloy material. Specifically, the shaft 2 may be made of metal material having a greater linear coefficient of expansion than titanium material which is described below.

In the present embodiment, the sleeve 4 is made of titanium material. Titanium material has a sufficient rigidity as the sleeve 4, and it also has a small linear coefficient of expansion (8×10⁻⁶/K) among metals. Titanium material is also suitable as sleeve material because it has high chemical resistance and is resistant to deterioration such as corrosion due to additive components in the bearing fluid (oil). By using titanium material as the material for the sleeve 4, the linear coefficient of expansion of the sleeve 4 can be made sufficiently smaller compared to that of the shaft 2. Thus, as the temperature of the shaft 2 and the sleeve 4 rises, the clearance between the shaft 2 and the shaft insertion hole 4a of the sleeve 4 can be reduced. As the temperature of the shaft 2 and the sleeve 4 lowers, the clearance between the shaft 2 and the shaft insertion hole 4a of the sleeve 4 can be increased.

Specifically as the temperature rises, the viscosity of the bearing fluid (oil) supplied to the clearance between the shaft 2 and the shaft insertion hole 4a of the sleeve 4 reduces, decreasing the bearing rigidity, while the clearance between the shaft 2 and the shaft insertion hole 4a of the sleeve 4 reduces, increasing the bearing rigidity. Consequently, the change in bearing characteristics due to the temperature rise is canceled so that a change in motor performance can be reduced.

In addition, as the temperature lowers, the viscosity of the bearing fluid (oil) supplied to the clearance between the shaft 2 and the shaft insertion hole 4a of the sleeve 4 increases, increasing the torque loss, while the clearance between the shaft 2 and the shaft insertion hole 4a of the sleeve 4 increases, decreasing the torque loss. Consequently, the change in the bearing characteristics due to the temperature decrease can be canceled so that a change in motor performance can be reduced.

Between the shaft 2 and the internal surface of the shaft insertion hole 4a of the sleeve 4, the bearing fluid such as lubricant oil is supplied. In the bearing fluid between the shaft 2 and the sleeve 4, a dynamic pressure is generated by the rotation of the shaft 2. Thus, the shaft 2 rotates within the shaft insertion hole 4a of the sleeve 4 with the periphery of the shaft 2 constantly covered with the bearing fluid.

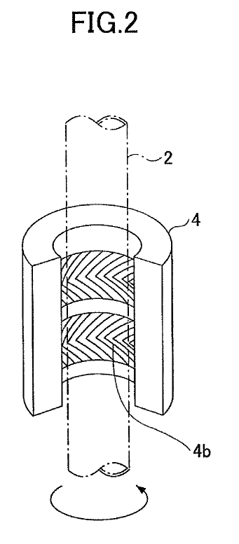

As a means to generate dynamic pressure in the bearing fluid, dynamic pressure grooves 4b are formed in the internal surface of the shaft insertion hole 4a of the sleeve 4, as shown in FIG. 2. The dynamic pressure grooves 4b, which may be generally referred to as herringbone grooves, consist of a number of fine grooves. The size of the dynamic pressure grooves 4b may vary depending on various conditions of the fluid dynamic bearing. For example, a number of V-shaped grooves with the depth of 10 μm may be arranged at the pitch of 100 μm so that the peak of each groove is oriented toward the rotating direction of the shaft.

Because the dynamic pressure grooves 4b are fine grooves and need to be formed in the internal surface of the through-hole 4b, their forming is difficult. In addition, when the sleeve 4 is formed of titanium material, there is the additional problem of the difficulty in processing titanium material.

After the study of various methods for micromachining titanium material, the present inventors found that the dynamic pressure grooves 4b could be formed through a particular etching process, as described below.

In an etching process, a non-light-transmitting layer, i.e., a resist, is formed on the surface of a mask, and then exposure, development and etching steps are performed to form a negative-positive inverted pattern on the mask surface. At the portion where a pattern (dynamic pressure grooves 4b) for the processed item (sleeve 4) is to be formed, a non-light-transmitting layer, i.e., a resist, is formed. Inserting the mask in the processed item (sleeve 4), exposure is performed to transfer the mask pattern onto the resist. After the resist is developed, etching is performed to form the mask pattern on the surface of the processed item (i.e., the internal surface of the shaft insertion hole 4a of the sleeve 4).

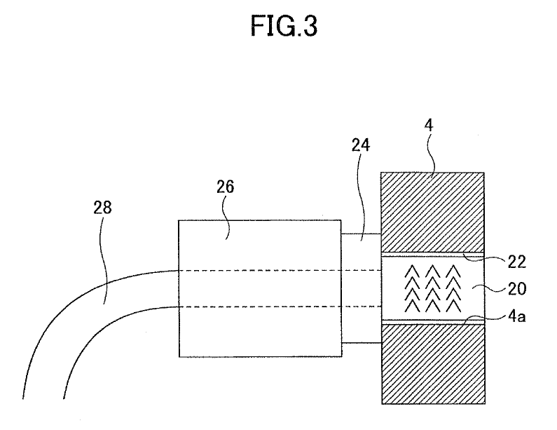

The etching process is described in detail below. FIG. 3 shows the structure of a photomask apparatus used in the etching process.

In FIG. 3, the internal surface of the shaft insertion hole 4a of the sleeve 4 made of titanium material is coated with a resist 22. The resist 22 is a photosensitive resist (UV-curing resist). Into the shaft insertion hole 4a, a mask member 20 is inserted which is columnar and that has a predetermined mask pattern (a pattern corresponding to the dynamic pressure grooves) formed on its outer surface. The material of the mask member 20 may be transparent glass or quartz, or resin material having transparency. Examples of the resin material include acrylic resin, polycarbonate, polyester, and PET (polyethylene terephthalate).

The mask member 20 is detachably attached to a support portion 26 via a connector 24. Thus, the mask member 20 can be replaced with another mask with a desired shape in accordance with the shape of the shaft insertion hole 4a of the sleeve 4. The mask member 20 is connected to a light-guiding cable 28 which may be made of a flexible optical fiber. Use of the flexible light-guiding cable 28 provides for the possibility of operating layout, thus improving operability.

The light-guiding cable 28 is connected to an exposure source (such as a UV light source), which is not shown. UV light emitted by the exposure source travels through the light-guiding cable 28 and reaches the mask member 20, exposing the mask pattern onto the resist 22.

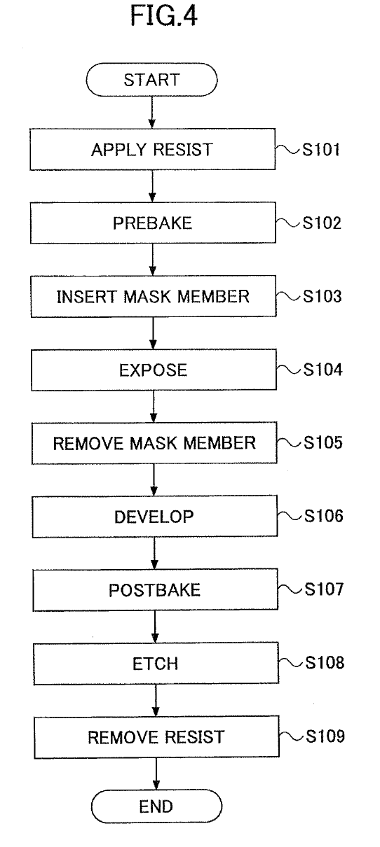

With reference to FIG. 4, a description is given of a procedure to form the pattern of the dynamic pressure grooves 4b on the internal surface of the shaft insertion hole 4a of the sleeve 4, using the aforementioned photomask apparatus. FIG. 4 shows a flowchart of the procedure.

First, the resist 22 is coated onto the internal surface of the shaft insertion hole 4a of the sleeve 4 (step S101). Specifically, a solution of the resist diluted with solvent is applied dropwise to the internal surface of the shaft insertion hole 4a, and then excess solution is removed. Other methods of forming the layer of the resist 22 include a dipping process dipping the object in a resist solution, flow-coating, rotary coating, spray coating, and electrodeposition.

The coated resist 22 is then prebaked (step S102), whereby, in order to evaporate the solvent in the resist applied in step S101, the temperature of the resist 22 is increased to a predetermined temperature.

The mask member 20 is then inserted into the shaft insertion hole 4a of the sleeve 4 (step S103), and exposure is performed via the mask member 20 (step S104). Specifically, the mask pattern formed on the outer surface of the mask member 20, which is inserted into the shaft insertion hole 4a of the sleeve 4 in step S103, is exposed onto the resist 22. After the mask member 20 is removed from the shaft insertion hole 4a (step S105), the resist 22 is developed (step S106), using a sodium carbonate solution, for example. In this way, the mask pattern is formed within the shaft insertion hole 4a of the sleeve 4.

Thereafter, the resist 22 is post-baked (step S107), which is a process of increasing the temperature of the resist 22 to a predetermined temperature in order to remove the solvent and moisture within the resist 22 and to increase the adhesion of the resist 22 to the internal surface of the shaft insertion hole 4a.

Etching is then performed (step S108), whereby the pattern of a predetermined depth is formed on the internal surface of the shaft insertion hole 4a of the sleeve 4 by removing the portion of the internal surface where the resist 22 does not exist.

Any etching method may be used as long as it is capable of etching titanium material. Examples are chemical etching such as dry etching and wet etching, and electrolytic etching. One example of dry etching is plasma etching. As a solution for wet etching titanium material, a solution of hydrofluoric acid or nitric acid may be used. As a solution for electrolytically etching titanium material, a solution of sulfuric acid may be used.

After the pattern (dynamic pressure grooves) of a predetermined depth is formed by etching, the resist 22 is removed (step S109). The resist 22 that has cured may be removed with a remover, such as a sodium hydroxide solution or an organic solvent.

To summarize the above, the resist 22 is applied to the portion of the internal surface of the shaft insertion hole 4a of the sleeve where the dynamic pressure grooves are formed, the mask member 20 is inserted into the shaft insertion hole 4a of the sleeve, and the steps of exposure, development, etching, and removal of the resist 22 are performed. In this way, the dynamic pressure grooves 4b can be formed on the internal surface of the shaft insertion hole 4a of the sleeve efficiently.

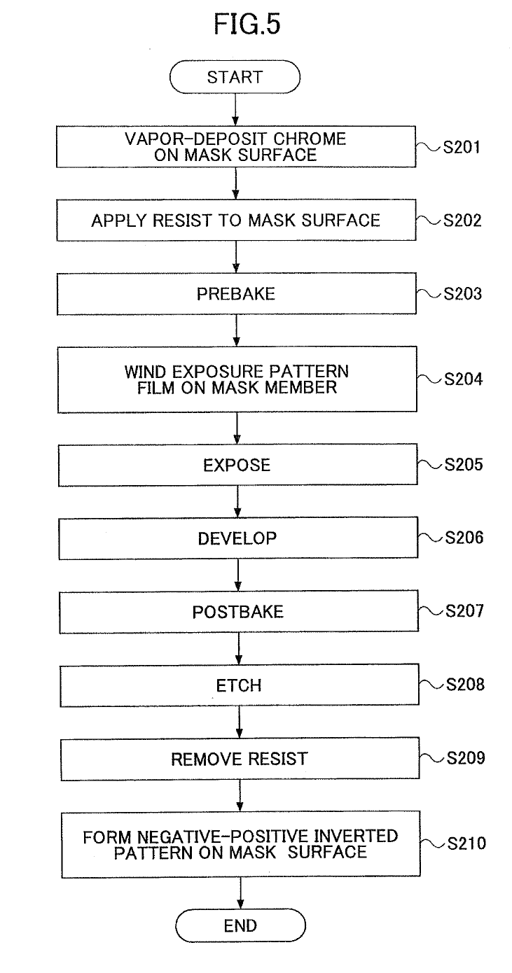

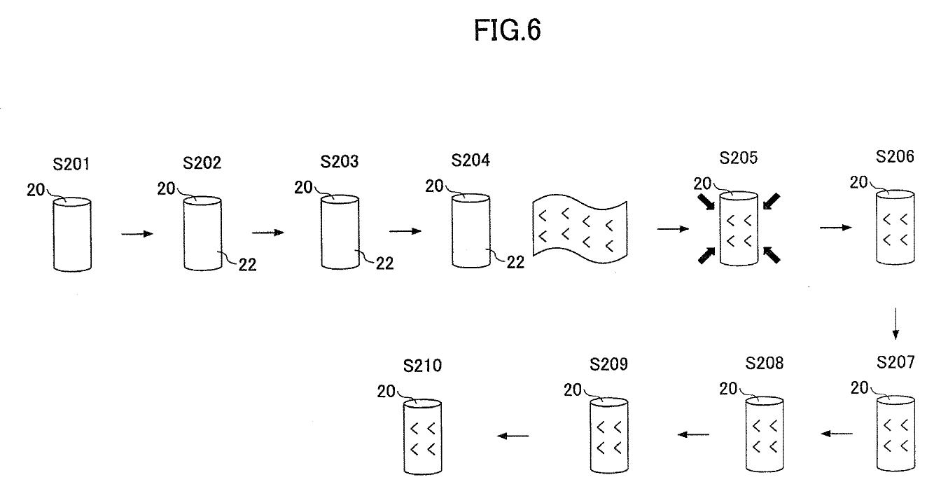

In the following, a description is given of a method of forming the exposure pattern (corresponding to the dynamic pressure grooves) on the outer surface of the mask member 20. FIG. 5 shows a flowchart of a process of forming the exposure pattern according to the method. FIG. 6 illustrates how the exposure pattern is formed in accordance with the process shown in FIG. 5.

First, the mask member 20 with a shape such that it can be inserted into the shaft insertion hole 4a of the sleeve 4 is prepared. The outer surface of the mask member 20 is provided with a non-light-transmitting layer by chrome deposition, plating, etc (step S201). The outer surface of the mask member 20 is then coated with a resist (step S202) and prebaked (step S203). The mask member 20 is then wound with an exposure pattern film (step S204) and exposed (step S205), and the resist is developed (step S206). The developed mask pattern is then post-baked (step S207).

Using the developed resist as a mask, the surface of the mask member 20 is etched (step S208), the resist is removed (step S209), and a negative-positive inverted pattern is formed on the surface of the mask member 20 (step S210).

While in the foregoing description with reference to FIG. 5 the pattern is formed on the surface of the mask member 20 by photo etching using an exposure pattern film, this is merely an example. In another example, the resist layer may be three-dimensionally scanned with laser light in order to form the predetermined pattern on the resist layer directly, instead of using the exposure pattern film.

Specifically, when forming the exposure pattern on the outer surface of the processed mask member 20 by a three-dimensional scan with laser light, after the mask member 20 with a shape such that it can be inserted into the shaft insertion hole 4a of the sleeve 4 is prepared, the surface of the mask member 20 is provided with a non-light-transmitting layer by chrome deposition, plating, etc. The surface of the mask member 20 is then coated with a resist and then prebaked.

The resist is then exposed by a three-dimensional scan with laser light. The exposed resist is developed and then post-baked. Using the developed resist as a mask, the surface of the mask member 20 is etched, the resist is removed, and a negative-positive inverted pattern is formed on the surface of the mask member 20.

Alternatively, the negative-positive inverted pattern may be directly drawn on the mask member 20 by removing the non-light-transmitting layer on the mask surface by a three-dimensional scan with laser light. For example, after preparing the mask member 20 with a shape such that it can be inserted into the shaft insertion hole 4a of the sleeve 4, the surface is provided with a non-light-transmitting layer by chrome deposition, plating, etc. The chrome deposition layer may be removed by three-dimensionally scanning it with laser light, thus directly drawing a negative-positive inverted pattern on the mask surface.

In this way, a pattern for forming the dynamic pressure grooves can be drawn on the outer surface of the transparent columnar mask member 20. While in the aforementioned example the mask member 20 is a transparent columnar member, the mask member may consist of a transparent cylindrical member in the internal surface of which the exposure pattern is formed.

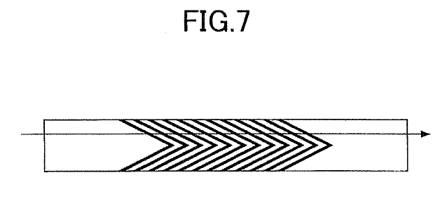

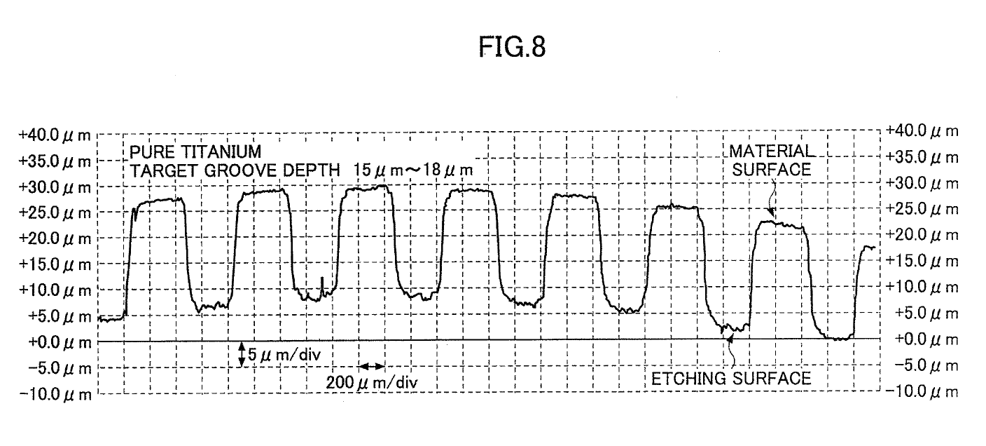

When fine grooves with the same shape as the dynamic pressure grooves were formed on the surface of titanium material by the aforementioned etching process, a good result was obtained. FIG. 7 illustrates the pattern of fine grooves formed on the titanium material. FIG. 8 shows the result of measuring the profile of the formed grooves using a surface roughness meter. The surface roughness meter was of stylus-type, with which the surface was scanned in the direction indicated by an arrow shown in FIG. 7. As shown in FIG. 8, grooves with a depth of approximately 20 μm were formed at the pitch of 800 μm. The width and depth required of dynamic pressure grooves are on the order of several hundred μm and several to 10 μm, respectively. Thus, it was shown that dynamic pressure grooves with a profile suitable for the surface of titanium material could be formed by the aforementioned etching process.

### EXAMPLE

A fluid dynamic bearing was fabricated by manufacturing the sleeve with titanium material and the shaft with martensitic stainless steel (SUS420J2), as mentioned above. The shaft had an outer diameter of 4 mm at room temperature (25° C.). The shaft insertion hole of the sleeve was fabricated to have a clearance c of 4 μm with respect to the shaft at room temperature (25° C.).

The bearing fluid supplied to the clearance between the shaft and sleeve consisted of an ester-based bearing oil. The bearing oil had a viscosity η of 20 cSt at room temperature (25° C.). The viscosity η of the bearing oil increased to 50 cSt at low temperature (0° C.) and decreased to 10 cSt at high temperature (50° C.).

### COMPARATIVE EXAMPLES

As comparative examples, fluid dynamic bearings were fabricated based on various combinations of conventional material for the shaft and sleeve.

### 1) Comparative Example 1

The shaft was made of martensitic stainless steel (SUS420J2) and the sleeve was made of copper alloy. This combination, which is very common in the relevant art, is problematic in that the ratios of change in bearing rigidity and torque loss are relatively large as ambient temperature changes.

### 2) Comparative Example 2

The shaft was made of austenitic stainless steel (SUS304) and the sleeve was made of martensitic stainless steel (SUS420J2). Because this combination is based on the same type of metal, seizing (adhesion) is likely to occur.

### 3) Comparative Example 3

The shaft was made of aluminum alloy and the sleeve was made of austenitic stainless steel (SUS304). Because the shaft is aluminum, the shaft is lacking in rigidity.

### 4) Comparative Example 4

The shaft was made of martensitic stainless steel (SUS420J2) and the sleeve was made of Invar material. Because Invar material has very small linear coefficients of expansion, it is suitable as a sleeve material in this respect; however, its market availability is low and machinability is poor, making it difficult to process the material into a practicable shape at low cost.

### 5) Comparative Example 5

The shaft was made of martensitic stainless steel (SUS420J2) and the sleeve was made of ceramics. Because ceramics has low linear coefficients of expansion, it is suitable as a sleeve material in this respect; however, its machinability is poor. Thus it is difficult to process ceramics into a practicable shape at low cost.

Based on the above combinations, the fluid dynamic bearings of Comparative Examples 1 through 5 were fabricated so that they had an outer diameter of the shaft of 4 mm at room temperature (25° C.), and a clearance c of 4 μm with respect to the shaft at room temperature (25° C.). The Comparative Examples 1 through 5 all used the same bearing oil as that of the Example.

The individual fluid dynamic bearings according to Comparative Examples 1 through 5 and the Example were operated at room temperature (25° C.), low temperature (0° C.), and high temperature (50° C.), and their bearing rigidity ratios and torque loss ratios were determined.

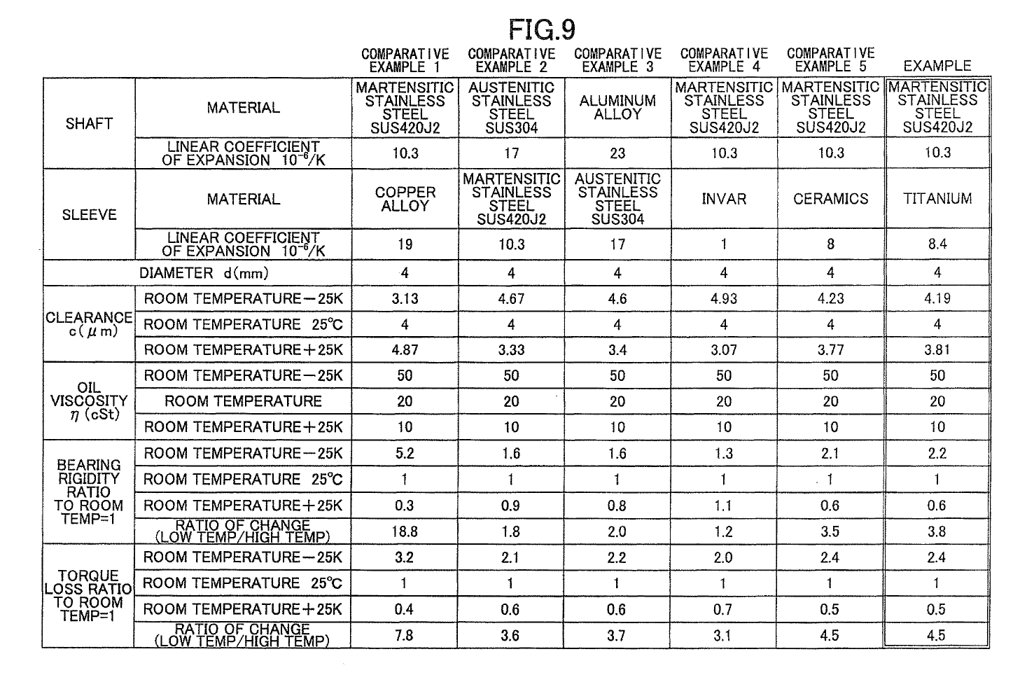

FIG. 9 shows the result of comparing the characteristics of the fluid dynamic bearing of the Example and the fluid dynamic bearings of Comparative Examples 1 through 5. In the table, the “bearing rigidity ratio” refers to the ratio of the bearing rigidity to the bearing rigidity at room temperature (25° C.). Specifically, it refers to the value of either (bearing rigidity at low temperature)/(bearing rigidity at room temperature) or (bearing rigidity at high temperature)/(bearing rigidity at room temperature). The “torque loss ratio” refers to the ratio of the torque loss to the torque loss at room temperature (25° C.). Specifically, it refers to the value of either (torque loss at low temperature)/(torque loss at room temperature) or (torque loss at high temperature)/(torque loss at room temperature).

As seen from FIG. 9, when the sleeve was made of titanium (Example), the ratios of bearing rigidity and torque loss were smaller than in Comparative Example 1, which was based on a conventional combination, resulting in a significant improvement. In Comparative Example 2, while the ratios of both bearing rigidity and torque loss were smaller than in the Example using titanium material, seizing (adhesion) occurs due to using the same type of metals, making its practical application difficult. In Comparative Example 3, while the ratios of both bearing rigidity and torque loss were smaller than in the Example using titanium material, the rigidity of the shaft is so small that its practical application is difficult. In Comparative Example 4 in which Invar material is used for the sleeve, the ratios of both bearing rigidity and torque loss were the smallest, thus offering the best characteristics. However, the material is not practical for cost reasons. In Comparative Example 5, while the ratios of both bearing rigidity and torque loss are comparable to those of the Example using titanium material, the very poor machinability of ceramics makes their manufacturing cost expensive.

Thus, it was shown that the Example according to the present embodiment of the invention, which uses titanium material as the sleeve material, is the most suitable in various respects including characteristics change, machinability, manufacturing cost, and material cost.

It is to be understood that the above discussion is merely illustrative of some of the many specific forms that represent applications of the principles of the present invention. Clearly, numerous and other arrangements can be readily devised by those skilled in the art without departing from the scope of the invention.

The present application is based on the Japanese Priority Application No. 2007-145093 filed May 31, 2007, the entire contents of which are hereby incorporated by reference.

What is claimed is:

1. A fluid dynamic bearing comprising:
a sleeve having a shaft insertion hole;
a shaft that is rotatably inserted into the shaft insertion hole of the sleeve; and
a bearing fluid disposed between an internal surface of the shaft insertion hole in the sleeve and the shaft;
wherein the shaft is formed of a material selected from a group consisting of steel, iron alloy material, aluminum alloy material, and copper alloy material, and the sleeve is formed of titanium material.

2. The fluid dynamic bearing according to claim 1, wherein a dynamic pressure groove is formed on the internal surface of the shaft insertion hole of the sleeve.

3. The fluid dynamic bearing according to claim 2, wherein the dynamic pressure groove is formed by etching process.

4. A fluid dynamic bearing motor including the fluid dynamic bearing according to claim 1, wherein the shaft is fixed to a rotor and the sleeve is fixed to a stator.

5. A fluid dynamic bearing-type disc drive comprising the fluid dynamic bearing motor according to claim 4 as a disc rotating motor.

6. A method of manufacturing a fluid dynamic bearing that rotatably supports a shaft, the method comprising the steps of:
forming the shaft with a material selected from a group consisting of steel, iron alloy material, aluminum alloy material, and copper alloy material;
forming a sleeve that rotatably supports the shaft with titanium material; and
forming a dynamic pressure groove on an internal surface of a shaft insertion hole in the sleeve by etching process.
